(19) United States
(12) Patent Application Publication
(10) Pub. No.: US 2026/0151880 A1
(43) Pub. Date: Jun. 4, 2026

(54) CHUCK

(71) Applicant: Yi-Min Li, Taichung (TW)

(72) Inventor: Yi-Min Li, Taichung (TW)

(21) Appl. No.: 18/966,189

(22) Filed: Dec. 3, 2024

(51) Int. Cl. B23B 31/117

(52) U.S. Cl. CPC B25B 23/0035; B23B 31/003; B23B 31/1071; B23B 2231/04; Y10T 279/3406

(57) ABSTRACT

A chuck includes a tube including a polygonal hole in communication with an axial hole, an aperture in communication with the polygonal hole, and an orifice in communication with the axial hole. A sleeve includes a passageway for movably receiving the tube, an annular groove in a wall of the passageway, and a conical hole in communication with the passageway. A shuttle is movable in the axial hole. A bead is in the aperture. A portion of the bead enters the polygonal hole when an opposite portion of the bead is abutted against a wall of the conical hole. A ball is in the orifice. A portion of the ball enters the axial hole to stop the shuttle when an opposite portion of the ball is abutted against a wall of the passageway. The ball is completely out of the passageway when the annular groove receives the ball.

### BACKGROUND OF INVENTION

### 1. Field of Invention

The present invention relates to a tool and, more particularly, to a chuck for a tool.

### 2. Related Prior Art

U.S. Pat. No. 7,424,841 discloses a conventional chuck including a tube (10), a movable member (20), a magnet (21), a sleeve, a collar, a bead and two balls. The magnet is fitted in the movable member. The movable member is movable in the tube. The tube is partially and movably in the collar. The collar is fitted in the sleeve. The bead is in an aperture of the sleeve. The balls are in two other apertures of the sleeve. In a position, the bead enters a recess of a bit of a screwdriver for example, thereby locking the bit to the chuck, and the balls enter two sloping ditches of the movable member, thereby locking the movable member to the sleeve. In another position, the bead is away from the recess, and the balls are away from the sloping ditches. Thus, a spring (11) pushes the movable member which in turn pushes the bit from the tube. However, the combination of the movable element with the movable member is accidentally movable from of the tube by the spring since there is no element to stop the movable member or the magnet.

U.S. Pat. No. 9,731,356 discloses a conventional chuck including a tool-receiving portion, a magnetic mechanism, and a locking mechanism. Normally, the tool-receiving portion is in a position and movable to another position when necessary. The magnetic mechanism includes a shuttle and a plug. The shuttle is movable in the tool-receiving portion. The tool-receiving portion includes an annular lip (86) used as an end of the movement of the shuttle. The plug is fitted in the shuttle. The plug provides magnetism for attracting a bit of a screwdriver for example. The locking mechanism includes two balls. In a position, the balls are away from the bit. In another position, the balls enter a circumferential groove of the bit, thereby locking the bit to the chuck. However, it is difficult to make the annular lip (86) in the tool-receiving portion. Moreover, the annular lip is weak and can easily be broken.

Therefore, the present invention is intended to obviate or at least alleviate the problems encountered in the prior art.

### SUMMARY OF INVENTION

It is the primary objective of the present invention to provide an effective chuck.

To achieve the foregoing objective, the chuck includes a tube, a sleeve, a shuttle, a magnet, a spring, a bead, and a ball. The tube includes a polygonal hole in communication with an axial hole, an aperture in communication with the polygonal hole, and an orifice in communication with the axial hole. The sleeve is movable along the tube, and includes a passageway for receiving the tube, an annular groove in a wall of the passageway, and a conical hole in communication with the passageway. The shuttle is movable in the axial hole. The magnet is connected to the shuttle. The bead is movable in the aperture. A portion of the bead enters the polygonal hole when an opposite portion of the bead is abutted against a wall of the conical hole. The ball is movable in the orifice. A portion of the ball enters the axial hole to stop the shuttle when an opposite portion of the ball is abutted against a wall of the passageway. The ball is completely out of the passageway when the annular groove receives the ball.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a bit and a chuck according to the preferred embodiment of the present invention;

FIG. 2 is a perspective view of the bit and chuck shown in FIG. 1;

FIG. 3 is a cross-sectional view of the bit and chuck shown in FIG. 2;

FIG. 4 is a cut-away view of the bit and chuck shown in FIG. 2;

FIG. 5 is another cut-away view of the bit and chuck of FIG. 2; and

FIG. 6 is a cross-sectional view of the chuck in another position than shown in FIG. 3.

### DETAILED DESCRIPTION OF PREFERRED EMBODIMENT

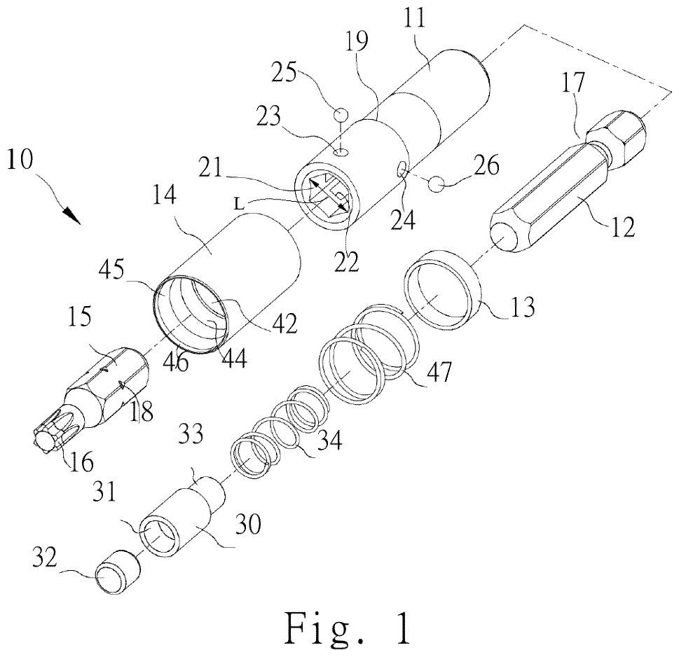

Referring to FIGS. 1 to 5, a bit 16 is holdable by a chuck 10. The chuck 10 includes a tube 11, a rod 12, a collar 13, a sleeve 14, a bead 25, a ball 26, a shuttle 30, a magnet 32 and two springs 34 and 47 according to the preferred embodiment of the present invention.

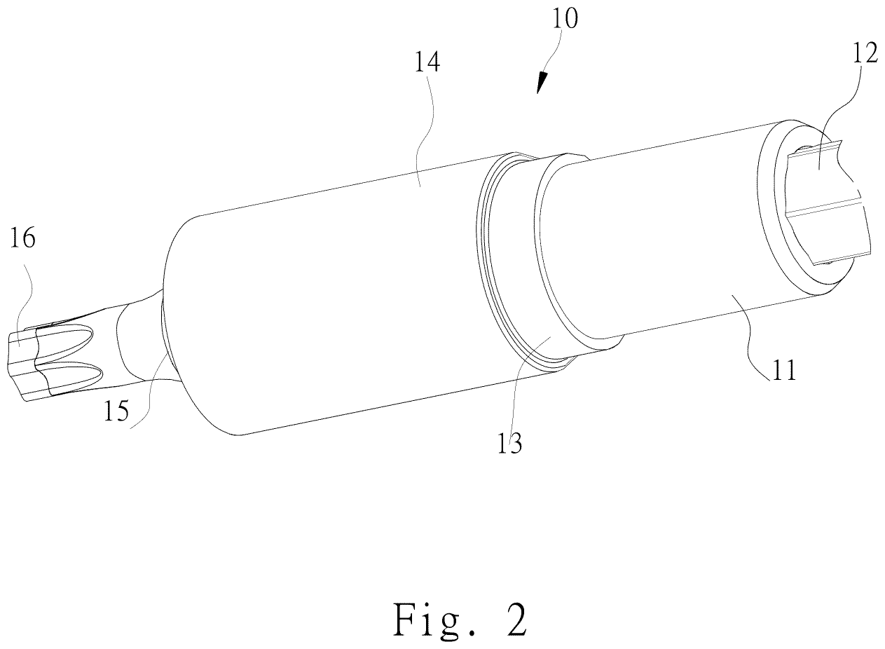

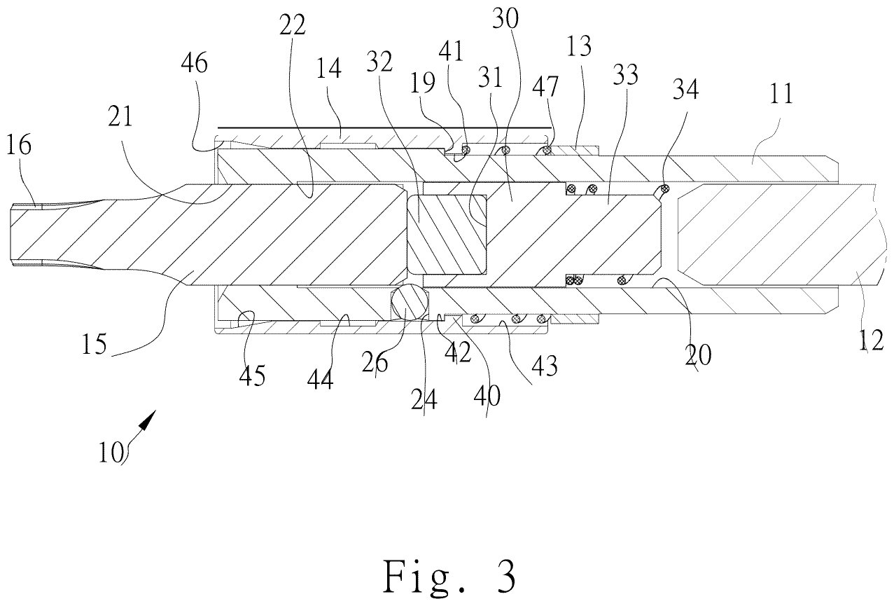

Referring to FIGS. 2 and 3, the tube 11 includes an axial hole 20 extending in a section of the tube 11 and a polygonal hole 21 extending in another section of the tube 11. The polygonal hole 21 is preferably a polygonal hole 21. A diagonal length of the polygonal hole 21 is larger than a diameter of the axial hole 20. A distance between two opposite facets (not numbered) of the polygonal hole 21 is smaller than the diameter of the axial hole 20. Thus, there is a shoulder 22 between each of the facets of the polygonal hole 21 and the axial hole 20.

Preferably, the rod 12 is preferably a polygonal rod fitted in a polygonal hole (not numbered) made in the tube 11. Thus, the rod 12 is not rotatable relative to the tube 11. There is adequate friction between the rod 12 and the tube 11 to keep the rod 12 in the tube 11. The rod 12 includes a circumferential groove 17 for keeping the chuck 10 connected to a manual, electric or pneumatic tool for example.

In another embodiment, the rod 12 is a circular rod fitted in the axial hole 20, thereby keeping the rod 12 in the tube 11.

In another embodiment, the tube 11 is inserted in a grip (not shown) that closes an end of the axial hole 20.

The shuttle 30 is inserted the axial hole 20. The shuttle 30 is kept in the tube 11 by the rod 12 or the grip. The diameter of the shuttle 30 is smaller than the diameter of the axial hole 20. The shuttle 30 is movable in and along the axial hole 20 of the tube 11 between the rod 12 and the shoulders 22. The shuttle 30 includes a cave 31 cut in an end and a protuberance 33 extending from another end. The cave 31 receives the magnet 32. The protuberance 33 extends toward the rod 12 or the grip. That is, the magnet 32 and the protuberance 33 extend opposite to each other.

The spring 34 extends around the protuberance 33, which is inserted in the axial hole 20. The spring 34 is compressed between the protuberance 33 and the rod 12 or the grip so that the shuttle 30 is biased from the rod 12 of the grip.

Referring to FIG. 3, the tube 11 includes two sections on the outside. An external diameter of the first section is smaller than an external diameter of the second section, thereby providing a circumferential shoulder 19 between the first and second sections. The first section of the tube 11 extends through the collar 13, the sleeve 14 and the spring 47.

Referring to FIG. 1, the sleeve 14 is a circular sleeve with an anti-skid element on an external face. The anti-skid element can be an embossed pattern for example.

Referring to FIG. 3, the interior of the sleeve 14 includes a passageway 42, a space 43, an annular groove 44 and a conical hole 45. The passageway 42 is located between the space 43 and the conical hole 45. The conical hole 45 includes as smaller end in communication with the passageway 42 and a larger end as an opening 46 of the sleeve 14. The annular groove 44 is cut in the wall of the passageway 42.

There is an annular shoulder 40 on an internal face of the sleeve 14 between the passageway 42 and the space 43. The annular shoulder 40 includes a facet 41. The diameter of the facet 41 is larger than the external diameter of the first section of the tube 11 but smaller than the external diameter of the second section of the tube 11.

The space 43 receives the first section of the tube 11. The passageway 42 receives the second section of the tube 11. The second section of the tube 11 is completely located in the passageway 42 when the annular shoulder 41 is located against the circumferential shoulder 19. The spring 47 is inserted in the space 43. The spring 47 is compressed between the annular shoulder 40 and the collar 13, which is fitted on the first section of the tube 11, thereby biasing the annular shoulder 40 from the collar 13. The abutment of the annular shoulder 40 against the circumferential shoulder 19 confines the movement of the sleeve 14 along the tube 11 to a proper range. The spring 47 is hardly compressed as the annular shoulder 40 is located against the circumferential shoulder 19.

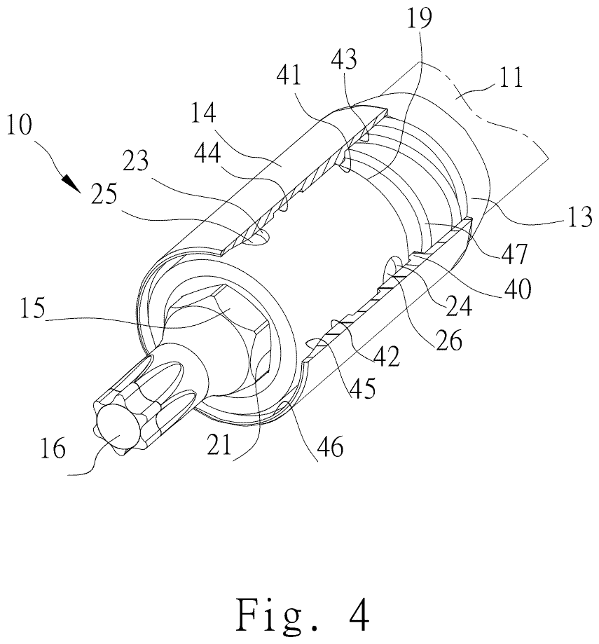

Referring to FIG. 4, the second section of the tube 11 is formed with an aperture 23 and an orifice 24. The sleeve 14 shields the aperture 23 and the orifice 24 as the passageway 42 receives the second section of the tube 11.

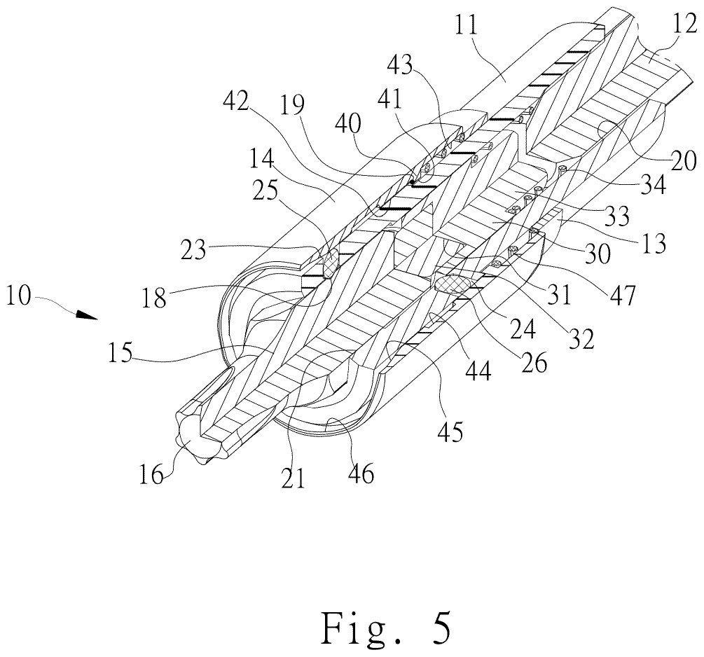

Referring to FIG. 5, the aperture 23 extends through the second section of the tube 11 along a diagonal of the polygonal hole 21. The aperture 23 receives the bead 25. The bead 25 is in contact with the wall of the passageway 42 and/or the wall of the conical hole 45 as the sleeve 14 is movable along the tube 11. The aperture 23 is so shaped that the bead 25 does not fall into the polygonal hole 21 from the aperture 23.

Referring to FIG. 3, the orifice 24 extends through the second section of the tube 11. The orifice 24 receives the ball 26. The ball 26 is in contact with the wall of the passageway 42 or the wall of the annular groove 44 as the sleeve 14 is movable along the tube 11.

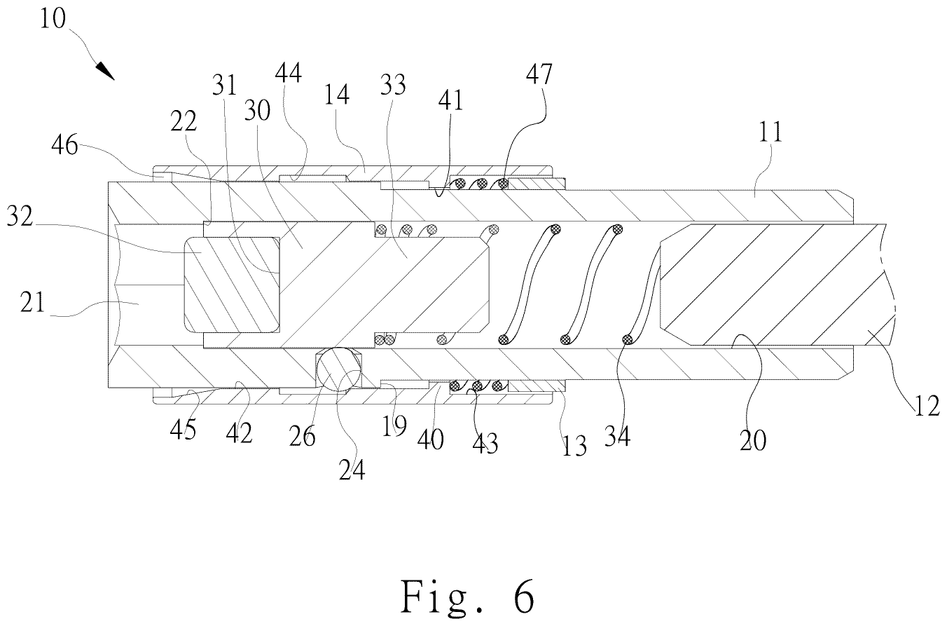

Referring to FIG. 6, the annular groove 44 receives a portion of the orifice 24 and the orifice 24 receives the remaining portion of the ball 26. Thus, the ball 26 is completely out of the axial hole 20 to allow the spring 34 to push the shuttle 30 toward the polygonal hole 21 over the ball 26. However, the shoulders 22 keep the shuttle 30 in the tube 11. That is, the shuttle 30 is movable relative to the tube 11 between the ball 26 and the shoulders 22.

Referring to FIG. 1, a bit 15 includes a front end 16. The front end 16 of the bit 15 is a Pozidriv, a Torx, slotted, cruciform, hexagonal or square for example. The bit 15 further includes six angles, each of which is made with a recess 18.

Referring to FIG. 6, an external force is used to move the sleeve 14 toward the first section of the tube 11 from the second section of the same. The annular shoulder 40 is moved toward the collar 13 so that the spring 47 is compressed. The annular groove 44 is aligned to the orifice 24 to allow a portion of the ball 26 to enter the annular groove 44 and allows an opposite portion of the ball 26 to leave the axial hole 20. Thus, the shuttle 30 is free from the ball 26. The spring 34 is allowed to move the shuttle 30 into the polygonal hole 21 over the ball 26. The shoulders 22 abuts the shuttle 30, thereby keeping the magnet 32 in the polygonal hole 21.

Although not shown, the conical hole 45 is aligned to the aperture 23 to allow the bead 25 to leave the polygonal hole 21. The bit 15 is insertable into the polygonal hole 21 while the shuttle 30 is moved deeply into the axial hole 20. The protuberance 33 is adjacent to the rod 12 so that the spring 34 is compressed between the shuttle 30 and the rod 12. At the same time, the magnet 32 attracts the bit 15.

Referring to FIG. 3, the sleeve 14 is released from the external force. The spring 47 is allowed to push the annular shoulder 40, thereby moving the sleeve 14 toward the second section of the tube 11 from the first section of the tube 11.

Referring to FIGS. 4 and 5, the conical hole 45 is away from the aperture 23. The wall of the passageway 42 abuts against a portion of the bead 25 so that an opposite portion of the bead 25 into the polygonal hole 21. The bead 25 enters one of the recesses 18, thereby keeping a rear section of the bit 15 in the chuck 10.

At the same time, the annular groove 44 is away from the orifice 24 to allow the wall of the passageway 42 to abut against a portion of the ball 26 so that an opposite portion of the ball 26 enters the axial hole 20.

Referring to FIG. 3, the ball 26 stops the shuttle 30, without interfering with the holding of the bit 15 by the chuck 10.

Referring to FIG. 2, the bit 15 is held by the chuck 10. The rod 12 can be connected to a manual, electric, pneumatic, or hydraulic tool (not shown). The front end 16 of the bit 15 extends from the chuck 10 and is available for driving a screw for example.

As discussed above, the shoulders 22 keep the shuttle 30 in the axial hole 20. Advantageously, the shoulders 22 are robust and hence affective for restraining the shuttle 30. Moreover, it requires a relatively easy process to make the diameter of the axial hole 20 smaller than the diagonal of the polygonal hole 21 and larger than the distance between two opposite facets of the polygonal hole 21 to provide the shoulders 22.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A chuck comprising:
a tube comprising:
a polygonal hole including a distance between two opposite facets thereof and a diagonal length between angles thereof;
an axial hole in communication with the polygonal hole, the axial hole includes a diameter larger than the distance and smaller than the diagonal length, thereby providing shoulders between the polygonal hole and the axial hole;
an orifice in communication with the axial hole; and
an aperture in communication with the polygonal hole;
a sleeve comprising:
a passageway for movably receiving the tube;
an annular groove in a wall of the passageway;
a conical hole in communication with the passageway;
a shuttle movable in and along the axial hole, wherein the shoulders keep the shuttle in the axial hole;
a bead movable in the aperture, wherein the conical hole includes a wall for contacting a portion of the bead, thereby inserting an opposite portion of the bead in the polygonal hole; and
a ball movable in the orifice, wherein the passageway includes a wall for contacting a portion of the ball, thereby inserting an opposite portion of the ball in the axial hole to stop the shuttle, wherein the annular groove is operable to receive the ball to allow the ball to completely move out of the passageway.

2. The chuck according to claim 1, further comprising a spring extending around the tube, wherein the tube further comprises a circumferential shoulder and a collar fitted around the tube, wherein the sleeve further comprises an annular shoulder located between the collar and the circumferential shoulder, wherein the spring is compressed between the collar and the annular shoulder.

3. The chuck according to claim 1, further comprising a rod fitted in the axial hole to block the shuttle.

4. (canceled)

5. The chuck according to claim 1, further comprising a magnet connected to the shuttle.

6. The chuck according to claim 5, further comprising a spring, wherein the shuttle further comprises a protuberance extending opposite to the magnet, wherein the spring extends around the protuberance, wherein the spring is compressed between the rod and the shuttle.
